(19) United States
(12) Patent Application Publication
(10) Pub. No.: US 2014/0369503 A1
(43) Pub. Date: Dec. 18, 2014

(54) SIMULTANEOUS BROADCASTER-MIXED AND RECEIVER-MIXED SUPPLEMENTARY AUDIO SERVICES

(71) Applicant: DOLBY LABORATORIES LICENSING CORPORATION, San Francisco, CA (US)

(72) Inventor: Will Kerr, Cricklade (GB)

(73) Assignee: DOLBY LABORATORIES LICENSING CORPORATION, San Francisco, CA (US)

(21) Appl. No.: 14/370,638

(22) PCT Filed: Jan. 8, 2013
(86) PCT No.: PCT/US2013/020665

§ 371 Date: Jul. 3, 2014

Related U.S. Application Data
(60) Provisional application No. 61/585,493, filed on Jan. 11, 2012.

(51) Int. Cl. G10L 19/008; H04N 21/439; G09B 21/00; H04N 21/43

(52) U.S. Cl. CPC G10L 19/008; H04N 21/4307; H04N 21/4398; G09B 21/006
USPC 381/2; 381/23; 381/22

(57) ABSTRACT

A combined signal (Z) is provided as an additive mix of a secondary audio signal (Y) and a phase-inverted reduced primary signal (Xₘ′) obtained from a primary audio signal. The secondary signal (Y) can be restored from the primary (X) and the combined (Z) signal by additively mixing the latter with a reduced primary signal (Xₘ) obtained from the primary signal. This coding approach allows a supplementary audio service, in particular an audio description/video description to be distributed alongside with a multi-channel audio signal at low extra bandwidth or storage cost.

### CROSS-REFERENCE TO RELATED APPLICATIONS

This application claims priority to U.S. Provisional Application No. 61/585,493, filed Jan. 11, 2012, the disclosure of which is hereby incorporated by reference in its entirety.

### TECHNICAL FIELD

The invention disclosed herein generally relates to supplementary audio services within audiovisual media broadcasting. In particular it relates to a coding format which integrates a supplementary audio service at small bandwidth overhead, as well as methods and devices for encoding and decoding signals in accordance with the format.

### BACKGROUND

In audiovisual media broadcasting, there is a need to provide supplementary audio services (associated audio). For instance, an Audio Description (EMEA term) or a Video Description (US term) is a narrative track designed to describe the on-screen action to allow visually impaired users to have an understanding of the action. The Audio Description/Video Description (AD) is mixed into the main audio. Several laws exist which require these services to exist. The main ones are, for the United States, the “Twenty-First Century Communications and Video Accessibility Act of 2010 (CVAA)” and, for the European Union, the “Audiovisual Media Services Directive (AVMSD, 2010/13/EU)”. Some countries additionally require a certain percentage of broadcasting to contain AD.

There are two existing methods of how the main audio and AD are mixed together.

Firstly, by the broadcaster-mixed approach, the mixing occurs inside the broadcast facility. This mix is then transmitted as an additional audio service. This may be mono, 2-channel or 5.1-channel stereo or other formats, but typically up until now, it has been mono or stereo, because the bandwidth of transmitting a complete additional 5.1 service is too great. It also means the mixing has to be 5.1 and stereo compatible. In broadcaster mixing, receivers just select which audio service to decode and present to the user either the main audio or the broadcast-mixed AD. Secondly, by in receiver-mixed approach, the mixing occurs within the consumer receiver. The AD is sent as a separate audio service, with some information to describe how to mix it into the main audio. The receiver has to contain two decoders, one for main audio and one for the AD. The receiver also has to contain a mixer.

Broadcasters and receiver manufactures are split in their support for broadcaster-mixed or receiver-mixed services. On the one hand, broadcaster-mixed services do not require a second audio decoder in the receiver but take additional bandwidth in the transmission compared to receiver mixed. They also do not allow the flexibility of allowing visually impaired users to enjoy 5.1 audio. On the other hand, receiver-mixed services allow the flexibility to mix into a 5.1 sound field, but require two decoders in the receiver.

To mention one example of receiver mixing, a person using the television set disclosed in US 2010/182502 A1 has the option of hearing the AD associated with the television signal (audio descriptor mode) or hearing the television signal audio only (standard mode). To this end, a processor is operable to separate from the television signal an audio descriptor component part for providing an AD of a corresponding video component part of the signal. However, the broadcasting network can be assumed to include a number of receivers that are not equipped with a processor capable of extracting the audio descriptor part. To enable all receiver to reproduce AD, it appears necessary to distribute a further audio signal, in which the audio descriptor component is included or not included, depending on what a legacy receiver would reproduce on the basis of the television signal from which the audio descriptor component part can be separated. Hence, the total broadcast signal will occupy additional bandwidth, the size of which is in fact greater than the audio descriptor component, especially for advanced, multi-channel audio formats such as 5.1 stereo.

Since broadcaster-mixing equipment can be expected to remain in use parallel to receiver-mixing equipment for a long time, there is a need for improved distributing methods.

### BRIEF DESCRIPTION OF THE DRAWINGS

Embodiments of the invention will now be described with reference to the accompanying drawings, on which:

FIGS. 1 and 2 are a generalized block diagrams of audio encoders;

FIG. 3 shows an implementation of a channel reduction processor in the encoder in FIG. 2;

FIG. 4 is a generalized block diagram of an audio decoder;

FIG. 5 shows an implementation of a channel reduction processor in the decoder in FIG. 4;

FIG. 6 shows an audio broadcast system comprising an audio encoder and audio decoder;

FIG. 7 schematically shows example signals appearing in the broadcast system in FIG. 6;

FIGS. 8, 9 and 10 illustrate coding formats for broadcast in the broadcast system in FIG. 6.

All the figures are schematic and generally only show parts which are necessary in order to elucidate the invention, whereas other parts may be omitted or merely suggested. Unless otherwise indicated, like reference numerals refer to like parts in different figures.

### DESCRIPTION OF EXAMPLE EMBODIMENTS

### I. Overview

An example embodiment of the present invention proposes methods and devices enabling distribution of additional audio services in a bandwidth-economical manner. In particular, an example embodiment proposes a coding format for audio-visual media broadcasting that allows both legacy receivers and more recent equipment to output additional audio services. Moreover, an example embodiment enables joint playback of additional audio services and multi-channel audio. An example embodiment of the invention provides an encoding method, encoder, decoding method, decoder, computer-program product and a media coding format with the features set forth in the independent claims.

A first example embodiment of the invention provides an audio encoding method having as input data a primary signal (X) in N-channel format and a secondary signal (Y). According to the first example embodiment, a reduced primary signal (Xₘ) is provided on the basis of the primary signal, either by extracting a component from the full primary signal or by proper downmixing. The reduced primary signal thus obtained is then phase-inverted and additively mixed with the secondary signal, and a combined signal (Z) is obtained. The reduced primary signal may include one or more channels, that is, 1≦M<N. The secondary signal may be in mono format or any stereo format. If the secondary signal is in stereo format, the additive mixing of the reduced primary signal and the stereo secondary signal amounts to mixing two multichannel signals.

The primary signal and the combined signal are the output of the audio encoding method, in the sense that any receiver which has access to these signals is in principle able to restore the secondary signal. However, if the method is implemented as an encoding unit, it is not essential that both the primary signal and the combined signal be output from the encoding unit; the primary signal may be supplied directly from the source to the receiver, such as via a bypass line.

The method may include a step of encoding the primary signal and the combined signal before these are output. As will be further detailed below, the signals may be encoded separately (e.g., using a transform-coding approach), may be multiplexed into one signal before encoding or may be encoded separately and then combined in a stream according to a bitstream format. Alternatively, the method outputs the primary signal and the combined signal in non-encoded format and forwards them to other processes responsible for encoding and possibly distribution to receivers, e.g., by broadcasting over a packet-switched network or by electromagnetic waves. It is envisaged that the audio signals discussed up to now are combined with one or more video signals and/or metadata before being handed over to downstream processes, as in a digital television broadcast system. It is noted that the terms “audio encoding method”, “audio encoder”, “audio decoding method”, “audio decoder” and “audio signal” are intended to encompass not only pure audio-related processes, devices and signals, but also processes and devices configured to handle a combination of audio data and data of a further type (e.g., video data), as well as any signal comprising an audio portion. As such, it is understood that an “audio encoding method” may refer to a television encoding method.

In a second example embodiment of the invention, there is provided a decoding method having as input data the primary (X) and the combined signal (Z). These signals may have been received from a broadcast and may be available in encoded or non-encoded format. Encoded signals may optionally be decoded before being subjected to the decoding method of the second example embodiment. The secondary signal (Y) contained in the combined signal is restored by providing a reduced primary signal (Xₘ) on the basis of the primary signal and mixing this additively to the combined signal. According to the second example embodiment, one component of the combined signal is the reduced primary signal. Because the reduced primary signal was obtained in equivalent ways both on the transmitter and the receiver side, and because the reduced primary signal component in the combined signal has inverted phase, the two reduced primary signal components will cancel upon the additive mixing, so that the secondary signal is obtained. It is noted that the secondary signal may be output together with the primary signal without further processing, or may be subject to subsequent downmix to match the capabilities of an available playback equipment.

In an embodiment of the present invention, the presence of the secondary signal component is optional during playback of the (reduced) primary signal, regardless of the receiver type. Indeed, a broadcast-mixing decoder without mixing capabilities may select whether to play the primary signal (without AD) or the combined signal (with AD). In the combined signal, the audio component corresponding to the primary signal will be present in a format with a reduced number of channels and with inverted phase. It is well known, however, that human hearing cannot determine whether or not an audio signal reproducing an original audio source has undergone a phase change with respect to the reference phase of the source. Turning to a receiver-mixing decoder which receives a primary signal and an associated combined signal, this decoder may either reproduce the primary signal as is (without AD) or may practise an embodiment of the invention to obtain the secondary signal. After this step, the receiver-mixing decoder mix the full N-channel primary signal with the secondary signal, whereby a full N-channel audio signal with the AD component is obtained.

In an example embodiment, the overhead required for distributing the AD need not be greater than that which the M-channel reduced primary signal occupies, wherein M=1 (mono) is the most economical option, which conserves bandwidth.

The dependent claims define example embodiments of the invention, which are described in greater detail, below.

The additive mixing on the encoder side may include adding timestamps to the combined signal, so that this can be synchronized on the decoder side with the primary signal. The presence of timestamps helps preserve synchronicity between the primary and the secondary signal. More importantly, it also contributes to more accurate cancellation between the phase-inverted primary component in the combined signal and the reduced primary component. For this purpose, it may be adequate to utilize timestamps included in an existing file or transport stream format, such as MPEG-2 and MPEG-4 (see ISO/IEC 13818-1 or ISO/IEC 14496-1, 14496-12 and 14496-14), particularly MPEG2-TS and MP4, wherein timestamps (e.g., presentation timestamps, PTS) are included in a packetization layer wrapped around audio access units. In an example embodiment, the timestamps contain sufficient information to allow individual samples to be aligned regardless of the coding format, so that efficient cancellation is achieved. As is well known in the art, the coding format may be equipped with a master time base, which serves as reference for aligning all other signals. This makes the decoding process robust in that there is no need to designate a signal as reference signal, so that alignment may still be ensured even though one or more signal does not reach the decoder or is temporarily interrupted.

To ensure that the reduced primary signal is provided both on the encoder and decoder side in a uniform manner, which is also in the interest of efficient and possibly complete cancellation upon decoding, this process (or a the processor responsible for carrying it out) is governed by a downmix specification. The downmix specification may relate to one or more of the following qualitative and quantitative characteristics of the mixing: downmixing gains (i.e., multiplicative coefficients by which different channels are additively summed), dynamic range compression, gain limiting behaviour to avoid overflow/clipping, transcoding processes, etc. Hence, the process of obtaining the reduced primary signal is easily reconfigurable by modifying the downmix specification. In particular, by configuring the process by means of identical downmix specifications both on the encoder and decoder side, it can be ensured that reduced primary signals obtained from one single primary signals (or faithful copies of this) are indeed identical. The downmix specification may influence the type of algorithm used for providing the reduced primary signal (e.g., downmixing, weighted downmixing, component extraction) but may also influence quantitative settings within an algorithm of a given type. The downmix specification may be included in a stored, transmitted or broadcast signal as metadata.

When an embodiment of the invention is practised, further measures may be taken in order to achieve of proper cancellation by ensuring uniformity between the phase-inverted reduced primary component, which the encoder includes into the combined signal, and the reduced primary signal, which is provided on the basis of the primary signal on the decoder side and intended to be mixed with the combined signal. Indeed, the reduced signal may be provided as the output of a two-step process. In a first step, a two-channel primary signal (X₂) is provided on the basis of the N-channel primary signal (X). In a second step, an M-channel reduced primary signal (Xₘ) is provided on the basis of the two-channel primary signal. The second step is trivial if M=2, but amounts to a stereo-to-mono downmix process if M=1. Since downmix procedures into two-channel format are widely standardized, the availability of a downmix specification is not mandatory. E.g., downmix from 5.1 format into two-channel stereo format may proceed in accordance with ETSI TS 102.366, section 6.8. On a technical level, this means that two copies of a standard component deployed on each of the encoder and decoder side will behave identically, so that there is no need to distribute a dedicated downmix specification governing the downmix process.

The primary signal and the combined signal may be multiplexed together and distributed as a single bitstream. This may simplify storage, transmission and broadcasting of the signals. Especially, if transmission takes place over a packet-switched network, approximately synchronous time frames of each signal are likely to be delivered as part of the same packet, which facilitates later synchronization without excessive buffering. As two main options, the multiplexing may be performed before encoding or after encoding. Multiplexing before encoding may be regarded as a multiplexing process of the combined signal and the primary signal into one audio elementary stream. On the other hand, multiplexing after encoding may amount to combining the encoded signals into a transport stream format (e.g., MPEG2-TS) or a file format (MP4).

In an example embodiment, timestamp information passes through the downmix process by which the reduced primary signal is provided, so that this signal contains sufficient synchronization information relating it to the primary signal. This will allow the reduced primary signal and the combined signal to be properly aligned before they are additively mixed, so that efficient cancellation takes place. Indeed, if the combined signal is timestamped so that it can be synchronized with the primary signal, then both the combined and the reduced primary signal are related to the primary signal through its timestamps. Put differently, the reduced primary signal includes timestamps which enable it to be synchronized with the combined signal; as noted, this may be achieved indirectly by referring to the primary signal. Further, in a situation where the primary signal and the combined signal both contain timestamps that are relative to a common master time base, the same effect may be achieved by providing the reduced primary signal with timestamps relative to the same time base, such as in a transport stream format in accordance with MPEP2-TS. Applying a procedure with these or similar properties is clearly a further way of adding timestamps to the reduced primary signal enabling it to be synchronized with the primary signal.

In an example embodiment, timestamp information passes through the first additive mixing process on the decoder side. The timestamp information originates either from the reduced primary signal or from the combined signal. This way, the secondary signal obtained by cancelling out the reduced primary component in the combined signal will contain timestamps enabling it to be synchronized with the primary signal in connection with the second additive mixing process. It is stressed that this measure ensures synchronization between the primary and the secondary audio components, but is unrelated to the cancellation of the reduced primary component and therefore no essential feature of the invention.

In an example embodiment, a dual-mode audio decoder is operable in a basic mode (without AD), wherein the primary signal is output without being processed other than by, e.g., decoding into waveform format or downmix to suit the number of output channels of the playback equipment. The dual-mode audio decoder is also operable in an extended mode, in which it outputs an extended signal (Xₑ) obtained by additively mixing the primary signal and the secondary signal derived using a decoding method according to an embodiment of the invention.

In an example embodiment, an audio decoder is operable in a single mode wherein the primary signal (X) and the extended signal (Xₑ) are output at the same time. The two signals may be output at distinct output terminals. In other words, without leaving the scope of the present invention, the basic mode and the extended mode referred to above may coincide.

In an example embodiment of the invention, further, an audio or audiovisual broadcast system comprises an audio encoder according to an embodiment of the invention and at least one audio decoder according to an embodiment of the invention. In the interest of achieving efficient cancellation of the reduced primary components during mixing, the channel reduction processors that are respectively located on the decoder and encoder are operable in a coordinated mode, in which they return equivalent outputs in response to identical input signals. As outlined above, this may be achieved by causing the provision of reduced primary signals on each side to be governed by identical copies of a downmix specification.

It is noted that the invention relates to all combinations of features, even if these are recited in different claims.

### II. Example Embodiments

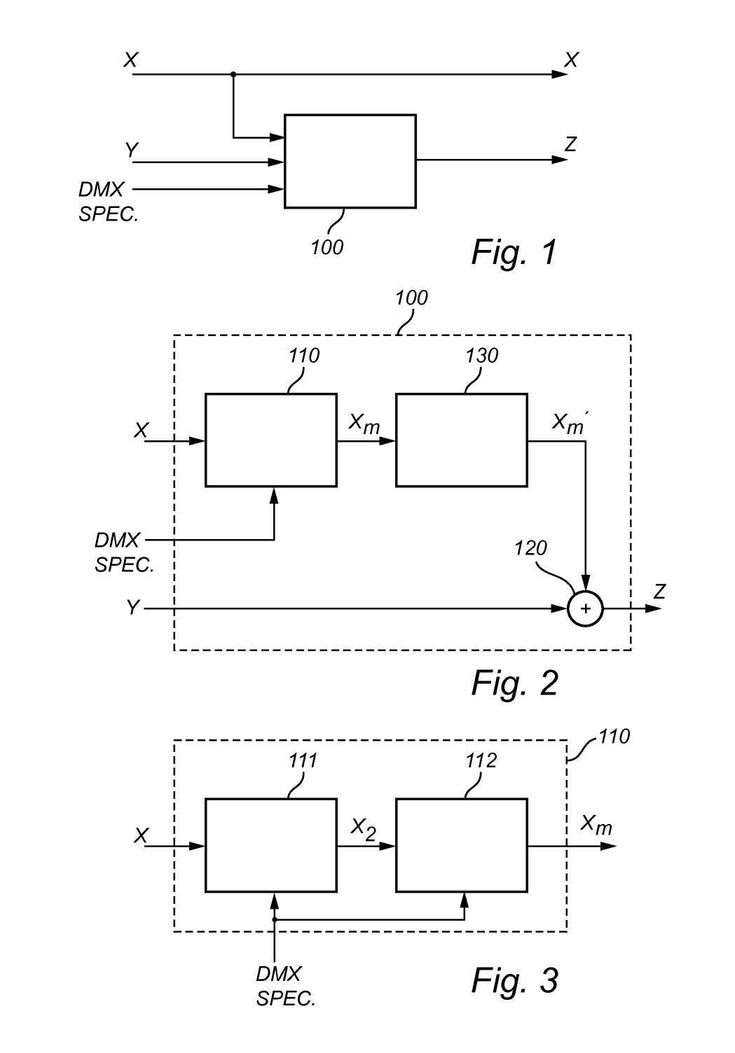

FIG. 1 shows, in block-diagram form and in accordance with an example embodiment of the invention, an audio encoder 100 for outputting a primary signal X and a combined signal Z on the basis of a primary signal X and a secondary signal Y. In the figure, the input side is located to the left and the output side is located to the right. As will be explained below with reference to FIG. 2, the input primary signal X is used in order to provide the combined signal Z, but may be output identically on the output side. In the example embodiment, therefore, the primary signal X is supplied from the input to the output side over a bypass line indicated at the top of the figure. As an optional feature of this example embodiment, the encoder 100 further accepts as input a downmix specification DMXSPEC. The downmix specification governs a channel reduction process executed in the encoder 100 and thus allows this process to be coordinated with a corresponding process in a decoder.

The components in the encoder 100 will be described below and may be located on the same device (e.g., a server, mainframe, desktop PC, laptop, PDA, television, cable box, satellite box, kiosk, telephone, mobile phone, etc.) or may be located on separate devices coupled by a network (e.g. , Internet, intranet, extranet, Local Area Network (LAN), Wide Area Network (WAN), etc.), with wire and/or wireless segments. In one or more example embodiments, the encoder 100 may be implemented using a client-server topology. The encoder 100 itself may be an enterprise application running on one or more servers, and in some embodiments could be a peer-to-peer system, or resident upon a single computing system. In addition, the encoder 100 may be accessible from other machines using one or more interfaces, web portals, or any other tool. In one or more example embodiments, the encoder 100 is accessible over a network connection, such as the Internet, by one or more users. Information and/or services provided by the encoder 100 may also be stored and accessed over the network connection.

The devices and methods disclosed herein may generally speaking be implemented as software, firmware, hardware or a combination thereof. Certain components or all components may be implemented as software executed by a digital signal processor or microprocessor, or be implemented as hardware or as an application-specific integrated circuit. Such software may be distributed on a data carrier (or computer readable media), which may comprise computer storage media and communication media. As is well known to a person skilled in the art, computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is known to the skilled person that communication media typically encompasses computer readable instructions, data structures, program modules or other data in a modulated data signal such as a carrier wave or other transport mechanism and includes any information delivery media.

The audio signals (or audio streams) referred to above may be compressed or uncompressed. The audio signals X, Y provided as input to the encoder 100 may be in the same or different formats. Examples of uncompressed formats include waveform audio format (WAV), audio interchange file format (AIFF), Au file format, and Pulse Code Modulation (PCM). Examples of compression formats include lossy formats such as Dolby Digital (also known as AC-3), Dolby Digital Plus (also known as, E-AC-3), Advanced Audio Coding (AAC), Windows Media Audio (WMA) MPEG-1 Audio Layer 3 (MP3) and lossless formats, such as Dolby TrueHD. In an example embodiment, an audio stream may correspond to one or more channels in a multi-channel program stream. For example, the primary signal X may include the left channel and the right channel, and the secondary signal Y may include the center channel. The selection of example audio signals (e.g., format, content, number) in this description may be made for simplicity and, unless expressly stated to the contrary, should not be construed as limiting an embodiment to particular audio streams, as embodiments of the present invention are well suited to function with any media format/content.

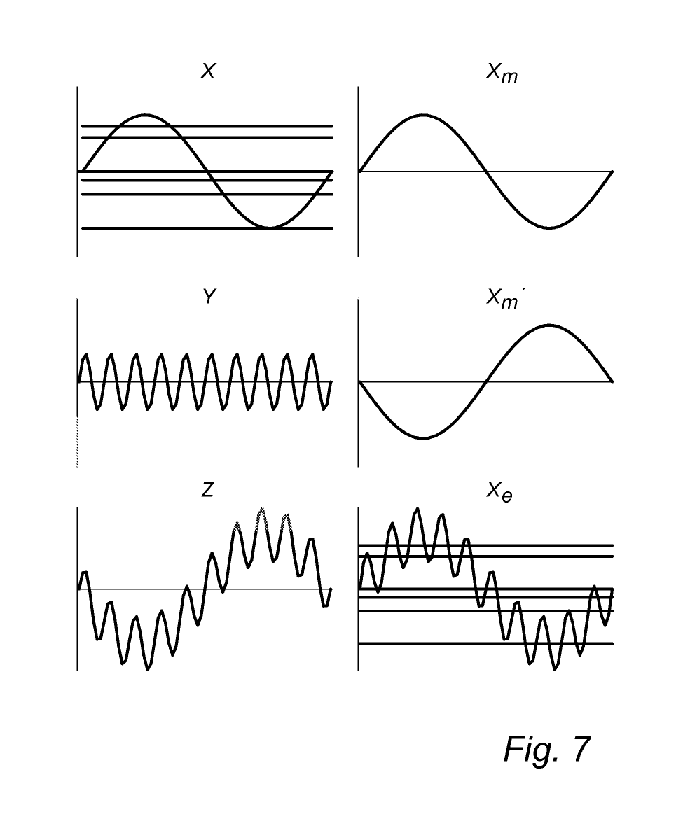

The above remarks concerning the encoder 100 apply similarly to the other example encoder embodiments of the invention to be described below. Likewise, these remarks are also valid in respect of the example decoder embodiments. FIG. 2 shows an audio encoder 100 for providing a combined signal Z on the basis of a primary X and a secondary Y signal. The encoder 100 comprises a channel reduction processor 110, the properties of which may optionally be adjusted by providing a downmix specification DMXSPEC. The channel reduction processor 110 provides a reduced primary signal Xₘ in M-channel format on the basis of a primary signal X in N-channel format, wherein 1≦M<N. As noted above, the channel reduction may proceed through additive mixing of the channel components or, as suggested by the graphs in FIG. 7, by extracting a most relevant component. The reduced primary signal Xₘ is forwarded to a phase inverter 130, which provides a phase-inverted primary signal Xₘ′. In an example embodiment, the phase inversion has the property that additive, time-synchronous mixing of the reduced primary signal Xₘ and the phase-inverted reduced primary signal Xₘ′ would cause these signals to cancel and form a near-zero signal, with low or negligible energy. The phase-inverted reduced primary signal is supplied to a mixer 120, which combines it additively with the secondary signal Y to obtain the combined signal Z, which forms the output of the encoder 100.

As suggested by the relevant graph in FIG. 7, the combined signal Z may be regarded as a superposition of the secondary signal Y and a phase-inverted few channel component Xₘ of the primary signal X, which is time-synchronous with the secondary signal Y. Further to the aspect of time synchronicity, it is appreciated that the temporal relationship between the primary X and secondary Y signal may carry over to the combined signal Z. This may be achieved through timestamping of the reduced primary signal Xₘ and the phase-inverted reduced primary signal Xₘ′, as discussed above, so that the latter signal can be properly aligned with the secondary signal Y in the mixer 120. Alternatively, it may be achieved by introducing a suitable delay, having the same magnitude as the delay introduced by the channel reduction processor 110 and the phase inverter 130, in the line from the secondary-signal input up to the mixer 120. In either case, as will be further detailed, it is advisable in view of decoding that the resulting combined signal Z carries information allowing it to be synchronized with the primary signal X.

With reference to FIG. 3, an example embodiment of the channel reduction processor 110 comprises a first downmix processor 111 arranged in series with a second downmix processor 112. The first downmix processor 111 is responsible for the N-to-2 channel downmixing, whereby it outputs a 2-channel primary signal X₂, and the second downmix processor 112 is responsible for the 2-to-M channel downmixing. As already noted, the downmix procedures into two-channel format are widely standardized, as are two-to-one channel downmix procedures. Hence, the optional downmix specification DMXSPEC may be omitted in either or both downmix processors 111, 112. It is appreciated that the internal structure of the channel reduction processor 110 may be varied further, as considered appropriate in view of the signals under processing and the availability of standardized hardware components or software processes.

FIG. 4 illustrates in block-diagram form a dual-mode audio decoder 200 comprising a channel reduction processor 210 and two mixers 220, 240. The channel reduction processor 210 is controllable by a downmix specification DMXSPEC. The decoder 200 is selectively operable in either of two modes, as symbolically illustrated by the presence of a switch 250 arranged upstream of the output terminal. When the switch 250 is in the upper position the primary signal X will be output without being processed. When the switch 250 is in the lower position, an extended signal Xₑ obtained on the basis of the primary signal X and the combined signal Z, which constitute input data to the decoder 200. In a first processing step, the combined signal Z is additively mixed, at the first mixer 220, with an M-channel reduced primary signal Xₘ supplied by the channel reduction processor 210. In view of the component structure of the combined signal Z and the cancelling property attributed to phase inversion, it may be expected that the output of the first processing step is a restored secondary signal Y. In a second processing step, effected at the second mixer 240, the primary X and secondary Y signals are additively mixed to form an extended signal Xₑ (cf. FIG. 7).

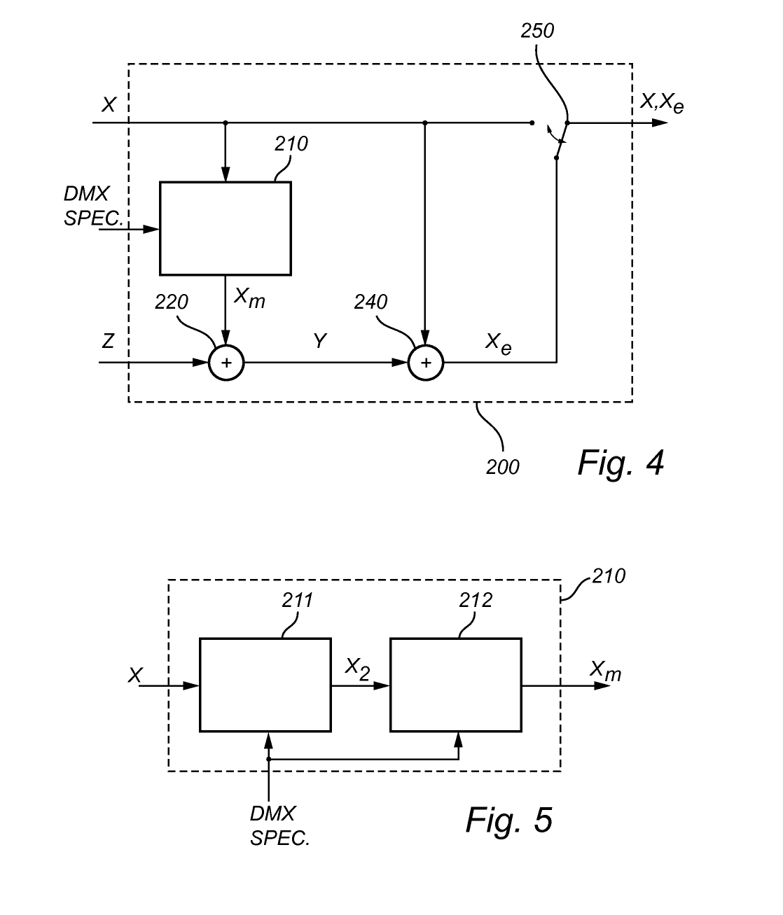

As shown in FIG. 5, the decoder 200 may, similarly to the encoder 100, contain a channel reduction processor 210 composed of two serially arranged downmix processors 211, 212.

Further to the time-synchronicity aspect already addressed, the channel reduction processor 210 in the decoder 200 is to convey timestamps or equivalent information from the primary signal X to the reduced primary signal Xₘ, to allow the first mixer 220 to mix this signal with the combined signal Z synchronously. This ensures efficient cancelling of the reduced-signal component. On the other hand, time synchronicity downstream of this point remains an optional feature of this invention. This is particularly true in cases where the primary X and secondary Y signals are not semantically so related that they are to appear synchronously in the extended signal Xₑ. As an example, perfect time synchronicity is not crucial when the primary signal X is a main television audio signal and the secondary signal Y is an audio description associated to this. While lip synchronization is widely regarded a desirable property of television audio, an audio description is typically free from speech produced by persons visible in the video signal.

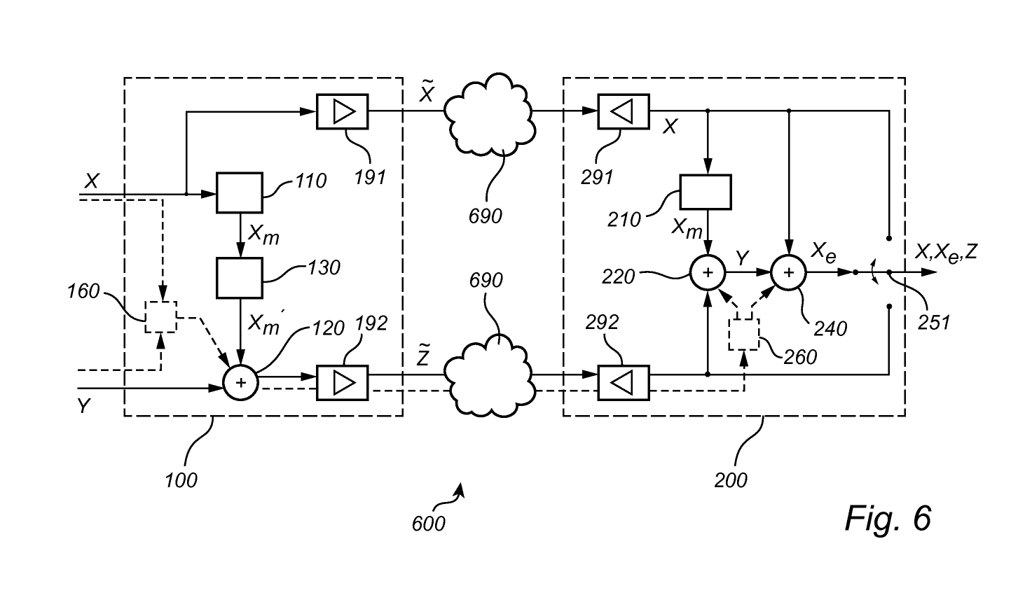

FIG. 6 shows an audio broadcast system 600 generally consisting of an audio encoder 100 and an audio decoder 200 communicatively connected via a broadcast network 690. The network 690 may be a packet-switched digital communication network (e.g., the Internet) or a communication link relying on electromagnetic wave propagation (e.g., analog or digital radio or television broadcasting over the air). The broadcast network 690 need not be bidirectional, but it is only essential that information may travel from the encoder 100 to the decoder 200.

It is noted that this system 600 may be adapted through very slight modifications to fulfil other tasks than broadcasting. For instance, by conceptually replacing the broadcast network 690 by read/write storage medium, the system may be used for storing and reproducing complex audio that includes a secondary signal (e.g., a supplementary audio service). The saving in bandwidth which the efficient coding format achieves in the broadcast system 600 will correspond to a saving in memory space in a storage system.

The encoder 100 has the same general structure as the encoders 100 shown in FIGS. 1 and 2, but further includes two bitstream-format encoders 191, 192 at its output side for converting each of the primary signal X and the combined signal Z into signals \tilde{X},\tilde{Z} in a format suitable for transmittal over the broadcast network 690, e.g., by packetization. Similarly, the decoder 200 includes at its input side two bitstream-format decoders 291, 292 for restoring the primary signal X and the combined signal Z on the basis of the bitstream-format signals \tilde{X},\tilde{Z}. As noted in a previous section, suitable bitstream formats include E-AC-3 and other bitstream formats compatible with MPEG-2 (e.g., MPEG2-TS) or MPEG-4 (e.g., MP4).

In the present example embodiment the decoder 200 shown in FIG. 6 includes a three-position switch 251, by which the decoder 200 is operable to output either the primary signal X, the extended signal Xₑ or combined signal Z. Each of the two latter signals include a secondary component, which possibly represents a supplementary audio service, but differ with respect to the number of channels included. The switch 251 is primarily of a conceptual nature and intended to illustrate the three-mode capability of the decoder. The decoder 200 may as well be a dual-mode decoder operable to output either of the primary signal X and the extended signal Xₑ. As outlined in a previous section, it is also possible to enjoy the information contained in the bitstream-format signals \tilde{X},\tilde{Z}, however at lower quality (fewer channels), if a simpler decoder is used. Of the components shown in FIG. 6, such simpler decoder need only contain the bitstream-format decoders 291, 292, from which the primary signal X and the combined signal Z are obtained. The supplementary audio service is present in the combined signal Z but not in the primary signal X, hence the user is free to choose whether to listen to the supplementary audio service.

In a variation to the above example embodiment, the switch 251 in the decoder 200 is replaced by a circuit (not shown) allowing simultaneous output of more than one signal. For instance, such decoder may be operable to output the primary signal X and the extended signal Xₑ in parallel. For example the primary signal X may be output to a main loudspeaker system, while the extended signal Xₑ may be conveyed in wired or wireless form to one or more headphones. Certainly, the extended signal Xₑ may be used as main audio and the primary signal X as headphones audio. By means of a decoder with this capability, an audiovisual programme can be enjoyed by a mixed audience comprising both individuals with normal eyesight and visually impaired persons. The circuit (not shown) replacing the switch may be two parallel bypass lines connecting the primary X and the extended Xₑ signal to respective output terminals. Alternatively, the circuit may comprise a bypass line for providing the primary signal X provided in parallel with a switch operable to output either the extended Xₑ or the combined Z signal.

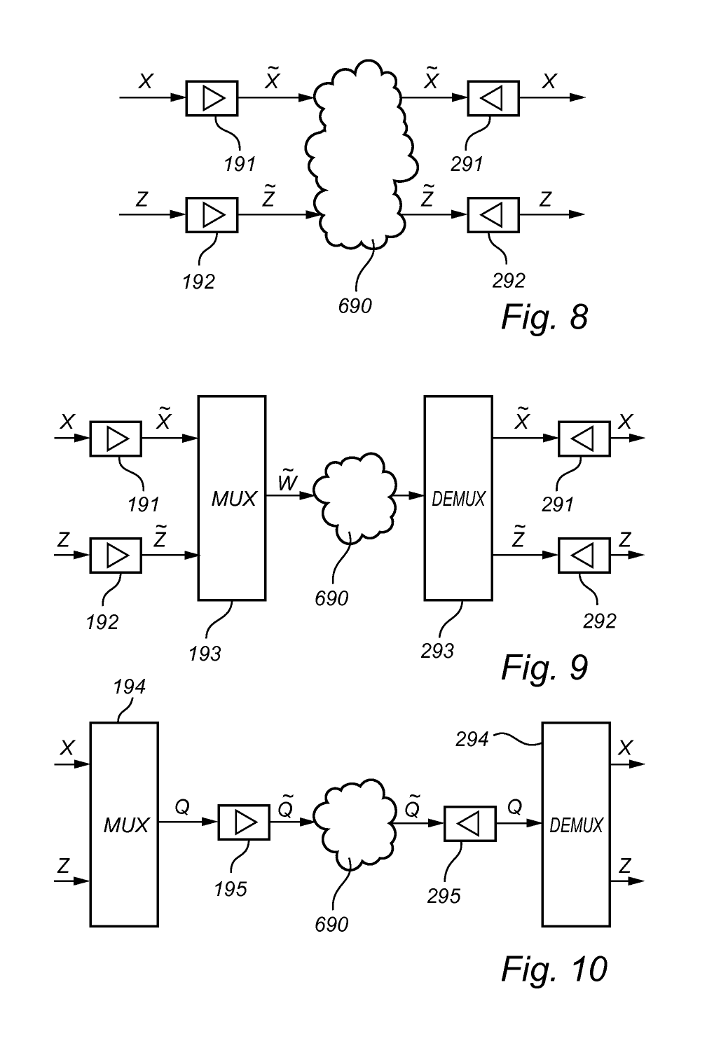

With reference to FIGS. 8, 9 and 10, it will be briefly described how the signals to be transported over the broadcast network 690 may be combined and possibly multiplexed. FIG. 8 shows a setup similar to FIG. 6, wherein each of the primary signal X and the combined signal Z follows a separate processing chain including conversion at the bitstream-format encoder 191, 192, transmittal over the broadcast network 690 as separate bitstream-format signals \tilde{X},\tilde{Z} and finally deconversion at the bitstream-format decoder 291, 292.

As an alternative to this, the two bitstream-format signals \tilde{X},\tilde{Z} may be multiplexed after conversion into one bitstream-format signal W̅. In terms of hardware, as shown in FIG. 9, this approach translates to providing a multiplexer 193 arranged on the encoder output side in series with the bitstream-format encoders 191, 192 and providing a demultiplexer 293 on the decoder input side in the same fashion.

Furthermore, as shown in FIG. 10, it is possible to multiplex the primary signal X and the combined signal Z into a single audio stream Q, based on which a bitstream-format signal Q is derived. Hence, the processing chain will include, in this order, a multiplexer 194, a bitstream-format encoder 195, the broadcast network 690, a bitstream-format decoder 295 and a demultiplexer 294. The primary signal X and the combined signal Z are restored at the output side of the demultiplexer 294.

With reference again to FIG. 6, it will finally be discussed how metadata can be transported and applied in the present broadcast system 600. Metadata may include information governing mixing. It may also include a downmix specification for coordinating the channel reduction processes on each of the encoder and the decoder side. The metadata may further relate to the formats used, synchronicity, and other quantitative or qualitative aspects of the broadcast process that either do not follow by standardisation or that may vary in the course of the process or between different implementations.

Illustrative flows of metadata are indicated by dashed lines, and the components responsible for processing the metadata are drawn in dashed line as well. More precisely, a first metadata processor 160 in the encoder 100 extracts metadata from either or both of the primary X and the secondary signal Y and supplies, on the basis of these, a control signal to the mixer 120. The control signal may for instance govern the time-synchronicity and/or the gains applied in the mixing, as well as advanced mixing features such as dynamic range compression or limiting strategies to prevent overflow. When the secondary signal Y relates to AD, it may be desirable to attenuate the primary signal X during active passages of AD, in order for the secondary signal to be clearly audible (cf. co-pending application published as WO 2011/044153 A1). The metadata to be extracted may originate from an external upstream authoring system (not shown), whereby the mixing metadata is created manually, or by a system upstream of the encoder. One example of a suitable metadata format is discussed in the paper T. Ware, “Audio Description Studio Signal”, WHP 198, British Broadcasting Corporation (August 2011). Hence, the metadata processor 160 allows properties of the mixer 120 to be altered in accordance with metadata present in the signals to be mixed.

The combined signal Z output from the mixer 120 includes further metadata, which propagate with the combined signal Z over the broadcast network 690 to the decoder 200, where it is extracted by a second metadata processor 260 and used to control the first mixer 220 and/or the second mixer 240. Similarly to the encoder mixer 120, the first mixer 220 and second mixer 240 may be adjustable regarding synchronicity and/or mixing gain. The metadata may also inform the second metadata processor 260 that the secondary signal Y is temporarily void of information, so that concerned component of the decoder 200 may be temporarily deactivated.

### III. Equivalents, Extensions Alternatives and Miscellaneous

Even though the invention has been described with reference to specific example embodiments thereof, many different alterations, modifications and the like will become apparent to those skilled in the art after studying this description. The described example embodiments are therefore not intended to limit the scope of the invention, which is only defined by the appended claims.

1-26. (canceled)

27. An audio encoding method, comprising:
inputting a primary signal (X) in N-channel format and a secondary signal (Y);
providing a reduced primary signal (Xₘ) in M-channel format based on the primary signal, wherein M<N;
phase-inverting the reduced primary signal and additively mixing it with the secondary signal to obtain a combined signal (Z); and
outputting the primary signal (X) and the combined signal (Z).

28. The method of claim 27, wherein said additive mixing includes adding timestamps to the combined signal enabling it to be synchronized with the primary signal.

29. The method of claim 27, further comprising inputting a downmix specification (DMXSPEC) governing said provision of the reduced primary signal.

30. The method of claim 27, wherein said provision of a reduced primary signal comprises:
providing a two-channel primary signal (X₂) based on the primary signal; and
providing a reduced primary signal (Xₘ) based on the two-channel primary signal.

31. The method of of claim 27, wherein the primary signal and the combined signal are multiplexed into a single bitstream, which is output.

32. An audio encoder, comprising:
a channel reduction processor for providing a signal in M-channel format based on a signal in N-channel format, wherein M<N;
a mixer for additively mixing two signals; and
a phase inverter connected between an output side of the channel reduction processor and an input side of the mixer,
wherein the channel reduction processor is configured to provide, based on a primary signal (X), a reduced primary signal (Xₘ) supplied to the phase inverter, and wherein the reduced primary signal after being phase inverted is mixed, by the mixer, with a secondary signal (Y) into a combined signal (Z).

33. The audio encoder of claim 32, wherein the mixer is configured to include timestamps to the combined signal enabling it to be synchronized with the primary signal.

34. The audio encoder of claim 32, wherein the channel reduction processor is adapted to input a downmix specification (DMXSPEC) and to be configured in accordance with this.

35. The audio encoder of claim 32, wherein the channel reduction processor comprises:
a first downmix processor for providing a two-channel primary signal (X₂) based on the primary signal; and
a second downmix processor for providing a reduced primary signal (Xₘ) based on the two-channel primary signal.

36. The audio encoder of claim 32, further comprising a multiplexer ( ) configured to multiplex the primary signal and the combined signal are multiplexed into a single bitstream, which is output.

37. An audio decoding method, comprising:
inputting a primary signal (X) and a combined signal (Z);
providing a reduced primary signal (Xₘ) based on the primary signal (X);
providing a secondary signal (Y) by additively mixing the combined signal and the reduced primary signal (Xₘ);
providing an extended signal (Xₑ) by additively mixing the primary signal (X) and the secondary signal (Y); and
outputting the extended signal.

38. The method of claim 37, wherein:
the combined signal (Z) includes timestamps enabling synchronization with the primary signal (X);
said provision of the reduced primary signal includes adding timestamps to the reduced primary signal enabling it to be synchronized with the primary signal; and
said provision of the secondary signal by additive mixing includes aligning the combined signal and the reduced primary signal (Xₘ) in accordance with the respective timestamps.

39. The method of claim 38, wherein:
said provision of the secondary signal includes adding timestamps to the secondary signal (Y) in accordance with timestamps in the reduced primary signal or timestamps in the combined signal; and
said provision of the extended signal (Xₑ) includes aligning the primary signal and the secondary signal in accordance with the timestamps in the secondary signal.

40. The method of claim 37, further comprising inputting a downmix specification (DMXSPEC) governing said provision of the reduced primary signal.

41. The method of claim 37, wherein said provision of a reduced primary signal comprises:
providing a two-channel primary signal (X₂) based on the primary signal; and
providing a reduced primary signal (Xₘ) based on the two-channel primary signal.

42. The method of claim 37, wherein the primary signal (X) and the combined signal (Z) are extracted from a single bitstream.

43. A data carrier storing:
a primary signal (X) in N-channel format; and
a combined signal (Z) comprising a phase-inverted reduced primary signal (Xₘ) in M-channel format additively mixed with a secondary signal (Y), wherein M<N and the secondary signal relates to a supplementary audio service associated with the primary signal,
said primary signal (X) comprising data enabling a copy of said reduced primary signal (Xₘ) to be restored in accordance with a downmix specification, whereby additive mixing of the copy of said reduced primary signal and the combined signal (Z) will yield the secondary signal (Y).

44. A dual-mode audio decoder, comprising:
a channel reduction processor for providing a signal in M-channel format based on a signal in N-channel format, wherein M<N; and
an first and a second mixer, each configured to additively mix two signals, wherein the audio decoder is operable in:
a) a basic mode, in which the decoder inputs a primary signal and outputs the primary signal; and
b) an extended mode, in which:
the decoder inputs a primary signal (X) and a combined signal (Z);
the channel reduction processor provides a reduced primary signal (Xₘ) based on the primary signal (X);
the first mixer provides a secondary signal (Y) by additively mixing the combined signal (Z) and the reduced primary signal (Xₘ); and
the second mixer provides an extended signal (Xₑ) by additively mixing the primary signal (X) and the secondary signal (Y), which extended signal is output by the decoder.

45. The decoder of claim 44, wherein:
the combined signal (Z) includes timestamps enabling synchronization with the primary signal (X);
the channel reduction processor is adapted to add, in the extended mode, timestamps to the reduced primary signal enabling it to be synchronized with the primary signal; and
the second mixer is adapted to align, in the extended mode, the combined signal and the reduced primary signal (Xₘ) in accordance with the respective timestamps.

46. The decoder of claim 45, wherein:
the first mixer is adapted to add, in the extended mode, timestamps to the secondary signal (Y) in accordance with timestamps in the reduced primary signal or timestamps in the combined signal; and
the second mixer is adapted to align, in the extended mode, the primary signal and the secondary signal in accordance with the timestamps in the secondary signal.

47. The decoder of claim 44, wherein the channel reduction processor to input a downmix specification (DMXSPEC) and to be configured in accordance with this.

48. The decoder of claim 44, wherein the channel reduction processor comprises:
a first downmix processor for providing a two-channel primary signal (X₂) based on the primary signal; and
a second downmix processor for providing a reduced primary signal (Xₘ) based on the two-channel primary signal.

49. The decoder of claim 44, further comprising a demultiplexer ( ) for extracting the primary signal (X) and the combined signal (Z) from a single bitstream.
